(19) United States
(12) Patent Application Publication
(10) Pub. No.: US 2008/0113143 A1
(43) Pub. Date: May 15, 2008

(54) Flexible Material and Method of Manufacturing the Flexible Material

(76) Inventor: David Stirling Taylor, Accrington (GB)

Correspondence Address: FITCH EVEN TABIN AND FLANNERY, 120 SOUTH LA SALLE STREET, SUITE 1600, CHICAGO, IL, 60603-3406, US

(21) Appl. No.: 11/926,472

(22) Filed: Oct. 29, 2007

Related U.S. Application Data
(60) Provisional application No. 60/863,633, filed on Oct. 31, 2006.

(51) Int. Cl. B32B 3/16

(52) U.S. Cl. 428/47

(57) ABSTRACT

A flexible protective padding material is described and comprises an array of resilient multilayered elements or blocks which have generally planar top and bottom surfaces and each of which have at least two layers which include a first layer bonded to an outer second layer. The total compressibility of each element with the at least two layers, the spacing between the elements and the total thickness of the elements provides the elements with the ability to compress such that at least one side wall of each of adjacent elements move together and touch each other to provide a joined outer surface of elements which dissipates a blow to the protective padding.

### FIELD OF THE INVENTION

This application relates to a material which combines compressibility, density and flexibility for use as protective padding, especially for protection of the human body during sports, or other physical activity which exposes the body to impact injuries. This application also relates to garments which incorporate the flexible material and a method of making the flexible material.

### BACKGROUND OF THE INVENTION

Protective wear and protective material conventionally comprise pads associated with fabric, often a stretch fabric, where the pads and fabric are inserted into pockets or sewn onto the garment or substrate. Often the padding or foam is perforated to permit or improve the wicking of perspiration from the body during strenuous physical activity. U.S. Pat. No. 5,689,836 to Fee et. al. describes such foam padding associated with a stretch garment.

U.S. Pat. No. 6,743,325 to Taylor describes a flexible material where a resilient polymeric foam material, such as closed cell polyethylene, is cut into a plurality of separate blocks and the blocks are adhesively affixed to a stretchable or elastic fabric. This flexible material easily conforms to a substrate shape with the small individual blocks of foam. Relatively large areas of fabric are available to permit flexibility and wicking perspiration from the body when the flexible material is part of a garment. The '325 patent to Taylor took a foam material and made it even more flexible with the use of compressible foam elements disposed upon stretchable fabric.

The flexible padding as described in U.S. Pat. No. 6,743,325, has proven helpful and desirable to people engaging in physical activities when light body contact is a concern. The foam elements of the '325 patent, however, are not arrayed and sufficiently stiff to dissipate a hard or extremely violent blow to the surface of the padding. When more violent body contact is a concern, such as in American football, skate boarding or being hit by a baseball, pads with a very hard surface shell with foam affixed to the hard surface shell has been used. U.S. Pat. No. 5,289,830 illustrates a skate boarding knee pad with a hard outer shell with soft foam backing. Pads with a hard surface or shell which has padding facing the wearer, however, have lacked flexibility because of the continuous relatively large inflexible shell. Further, soft pads associated with hard shells often are heavy. Hence, a need exists to provide greater protection from substantial impact forces while still retaining the flexibility of prior foams. For example, it has been determined that a need exists for protection of the chest of baseball players who may be impacted by a strongly thrown or hit ball. Lacrosse and field hockey players are constantly at risk of being hit by a stick. Also, impact force protection may be desired for athletes who contact others with a forearm such as American football players and rugby players. Hence, the problem has been to make an inherently stiffer pad, which will dissipate a hard blow, more flexible.

### SUMMARY OF THE INVENTION

The above described needs are met in accordance with flexible protective padding material described herein. The flexible protective padding material comprises an array of resilient multilayered elements or blocks which have generally planar top and bottom surfaces and each of which have at least two layers which include a first layer bonded to an outer second layer. The first layer worn next to the body has a first compressibility of at least about 110 kPa at deflection of 50% and a first density of at least 30 kg/m³; and the second or outer layer has a second compressibility of at least about 400 kPa at deflection of 50% and a second density of at least 90 kg/m³, the second layer denser than the first layer and not being as compressible as the first layer. The total compressibility of each element with the at least two layers, the spacing between the elements and the total thickness of the elements provides the elements with the ability to compress such that at least one side wall of each of at least two adjacent elements move together and touch each other to provide a joined outer surface of elements which dissipates a blow to the protective padding. The blow to the padding causes adjacent elements to coalesce against each other to instantly provide a continuum of padding adjacent the item which is hitting the padding. This action creates a continuous surface provided by the denser outer layer to dissipate the force impinging on the padding. Hence, the padding comprising the array of multi-layered resilient elements in spaced relation to each other is extremely effective for mitigating the effect of a hard impact to the padding. Generally, the two or more elements will compress at least about 10% under such an impact force which moves the elements together.

In an important aspect, the first layer, which is to be worn next to the body of the user, is spongier than the second layer and has a first compressibility (compressive strength) of from about 110 kPa to about 210 kPa at deflection of 50%, preferably from about 160 to about 210 kPa at 50% deflection, and density of from about 30 to about 50 kg/m³; and the second layer, which is to be worn away from the body of the user, is harder than the first layer and has a second compressibility (compressive strength) of from about 400 kPa to about 700 kPa at deflection of 50%, preferably from about 560 to about 700 kPa at defection of 50%, and a second density of from about 90 to about 200 kg/m³; and which second density is greater than the first density. The surface of the second layer, which when worn as part of a garment faces way from the wearer, is generally planar. The surface of the first layer facing the opposite direction and which faces toward the wearer of a garment, also generally is planar. The array of resilient elements is bonded to a stretchable fabric by affixing the planar surface of the first layer of the resilient elements to the stretchable fabric such that the resilient elements are in spaced a arrangement to each other on the stretchable fabric. In an important aspect, the spaced arrangement of the array of elements is such that the distance between the elements is from about 1 mm to 6 mm depending on how large the surfaces of each of the elements are. When the elements are hexagonal in shape, and the opposite linear sides of the hexagon are 10 mm, the distance between the elements should be in the range of 1 to 4 mm. When the opposite linear sides of the hexagonal elements are 35 mm, the gap or distance between the elements should be about 3 to 6 mm. The thickness of the elements should be between about 5 to about 25 mm. While the elements may be squares or any geometrical shape which will permit the elements to coalesce or nest into a continuous outer surface, the geometrical shapes of a hexagon or equilateral triangle are preferred as they will readily coalesce or nest into a continuous protective surface.

In an important aspect, the array of elements with one side of the elements bonded to stretch fabric such that the spaced array or arrangement of elements is effective for permitting the fabric with the multilayered elements bonded thereon to be folded over on itself in an arc of about 180° such that the fabric side of the padding overlies upon itself with the elements being exposed to the viewer. Yet, the same padding is quite flexible if folded such that the elements on the fabric are folded onto one another. When hexagonal elements are 1 cm thick, 23 mm from linear side to linear side and spaced about 4 mm apart are mounted on stretchable fabric, these elements are capable of being folded toward each other to form a cylinder with an inner diameter of about 75 mm, the stretchable fabric forming the outer diameter.

In another important aspect, the planar surfaces of the second layers are bonded to a second stretchable fabric so that the elements are sandwiched between the first and second fabrics. The plurality of resilient elements affixed to the stretchable fabric substrate and spaced from each other in an array form a padding which can be worn in or as a part of a protective garment such as a chest protector or forearm protector.

In an important aspect, the multi layered resilient elements comprise a resilient foam material having different densities and compressibilities. These foams should be closed cell forms. Exemplary of the foams which may be used include closed cell polyethylene foam, ethylene propylene non-conjugated diene polymer foam (EPDM polymers), expanded polyvinyl chloride foam, ethylene vinyl acetate (EVA) foams and rubbers and could comprise a number of different types of foams to give desired resilient, flexible, density and hardness properties. When closed cell foam is used for the elements, the relative compressibilities and densities of the layers making up the elements are selected such that at least two sides of the elements will touch each other and coalesce such that they will have a continuous outer surface between themselves when laid on a planar surface and when at least two elements are impacted with a force which compresses them at least about 10% when the at least two elements are 5 to 20 mm thick and are spaced at intervals of 1 mm to 6 mm. The multilayered resilient elements may be substantially identical in shape or alternatively they can be of different size and shape, for example to fit comfortably part of a wearer's body, or some other article, but they should coalesce as described above. The elements preferably take the form of hexagonal or triangular blocks, but they can be cubes or octagonal in cross-section. As long as the spacing, thickness and densities described above are maintained, the elements may be arrayed on the fabric substrate with a density of between 100 and 8000 elements/m².

The substrate for the multilayered resilient foam elements is a resiliently stretchable or elastic fabric. Suitable fabrics include knitted nylon and polyester fabrics and more particularly those materials comprising elastane. The fabric should readily stretch 50% to 200% without tearing when tensioned under normal wearing conditions. The present invention also contemplates fabric having so-called “two-way” stretch, i.e., stretch in opposite (parallel) directions along a common direction line, but in an important aspect the fabric should be a four-way stretch fabric. As understood, so-called “four-way stretch” fabrics are typically made of artificial fibers woven with a warp knit and so-called “two-way stretch” fabrics are typically made of artificial fibers woven with a circular knit.

In another important aspect and as noted above, a second layer of a flexible substrate material is preferably bonded over the elements so that they are sandwiched between two layers. As with the first substrate layer, the second layer of fabric is resiliently stretchable or elastic, which helps to prevent puckering of one side of the material when it is flexed. Advantageously, both substrate layers are resiliently stretchable.

In an important aspect, the flexible protective padding made from the multilayered elements may be incorporated into garments. In this aspect, fabric of the garment may form the fabric substrates for the multilayered foam elements. In one aspect, the padding is sandwiched between two fabric layers which are a part of the garment. In one aspect of this embodiment, the flexible fabric substrate with the small resilient multilayered blocks adhesively affixed thereto forms or serves as inner surface of a fabric garment. Preferably fabric serves as top and bottom fabric layers with the inner surface fabric being stitched as the inner surface of the garment and the garment fabric serving as an outer fabric surface bonded to the resilient multilayered foam elements. In any event the flexible material is particularly suitable for incorporation into protective clothing, for example where the garment has shoulder pads, knee pads, shin pads, hip pads, arm bands, head-guards, and vests and where the garment should be washable. It will be appreciated that in these garments the blocks are provided where required and omitted from certain areas of the garment. For example, in a headguard no blocks need be positioned in the ear-flaps of the guard.

In another aspect, a method for making the multilayered elements and padding is provided. In this aspect, the first layer comprising a polymeric foam web with a compressibility of from about 110 kPa to about 210 kPa at deflection of 50%, preferably from about 160 to about 210 kPa at 50% defection and density of from about 30 to about 50 kg/m³ is bonded to a second polymeric foam web having compressibility of from about 400 kPa to about 700 kPa at deflection of 50%, preferably about 560 kPa to about 700 kPa at 50% defection and a density of from about 90 to about 200 kg/m³ to provide a multilayered resilient web. In an important aspect the webs are melt bonded to the other.

After melt bonding and using a cutter, the multilayered resilient web or sheet is cut to provide an array of resilient multilayered blocks. The cutter may not cut completely through the multilayered web, but only partially through the web to remove foam material between the resilient element to provide an array of separated resilient foam elements extending from the first foam layer. Alternatively the cutter cuts completely through the multilayered foam web and then acts as a jig to hold the separate elements in place and in spaced relation while the substrate fabric layer is applied thereto. The cutter is adapted so that the one side of each, now cut, element are made to stand proud of the surface of the cutter grid. The sheet material may spring back slightly after cutting to accomplish this. Alternatively, ejectors, may be provided to achieve this effect.

In one embodiment of the method, a sheet of a resilient multi-layered material is provided where both sides of the sheet is coated with a hot melt adhesive to bond the elements to the substrate fabric. Preferably, the hot melt adhesive is a thin film which also is cut with the multi-layered foam sheet. The foam sheet with the film sheet of adhesive is placed, adhesive side up, over a cutter grid arranged to cut the sheet into a plurality of elements, for example hexagons. The foam sheet is pressed down onto the cutter to cut through the sheet. Excess material from between the elements is then removed. A resiliently stretchable substrate is placed over the, now cut, sheet and heated to activate the adhesive to join the elements to the substrate. The substrate is then lifted away from the cutter, taking the elements with it. The substrate with the foam elements then is heated, and optionally stitched into a garment.

The cutter grid can act as a jig, holding the elements in placed while the substrate layer is applied. If the flexible material is to be cut into large pieces, in particular large irregularly shaped pieces, then these pieces may be assembled into a specially constructed jig to hold them into place before application of the substrate. Conveniently, as before the sheet of resilient foam material from which the elements are cut has an adhesive layer applied to one or both surfaces prior to the cutting process.

### BRIEF DESCRIPTION OF THE DRAWINGS

Embodiments of the various aspects of the invention will now be described by way of example with reference to the accompanying drawings.

FIG. 1 is a perspective view of part piece of flexible material according to the invention;

FIGS. 2A and 2B are views which show how the elements coalesce so that the top surface of the elements of the flexible material becomes a continuous surface when impacted;

FIG. 3 is a diagram of equipment employed to produce two layer foam material;

FIG. 4 is a plan view of a cutter grid;

FIGS. 5 to 7 are vertical cross-sectional views of apparatus used in the manufacture of material as shown in FIG. 1 at various stages respectively throughout the manufacturing process;

FIG. 8 is a cross-sectional view through another embodiment of a flexible material according to the invention;

FIG. 9 is a perspective view of a two-layer element of hexagonal cross-section;

FIG. 10 is a plan view of spaced apart hexagonal elements as adhered to a substrate;

FIG. 11 is an arm protector including two layer elements; and

FIG. 12 is a chest protector with the elements of the flexible padding shown in the cut away in the surface of the protector.

### DETAILED DESCRIPTION OF THE PREFERRED EMBODIMENT

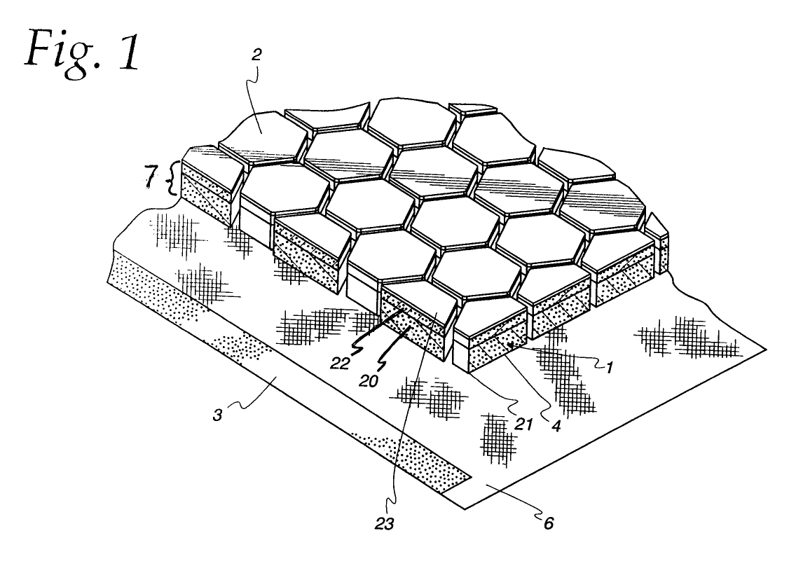

Referring to FIG. 1, the flexible material comprises a plurality of resilient multilayered hexagonal blocks 1 of a resilient closed-cell polyethylene foam, having sides of approximately 14 mm long and 12 m thick, joined with a hot melt adhesive to a fabric substrate 6. Each multilayered resilient hexagonal block is formed of two planar layers of hexagonal cross sections 2 and 4 of closed cell polyethylene foam bonded together. In FIG. 1, the layer bonded to substrate 6 is represented by the numeral 20 and the outer layer is represented by numeral 22. These layers form a laminate 7 and are referred to herein as bottom layer 20 and top layer 22 due to their positioning in FIG. 1. Top foam layer 22 has a density greater than the density of bottom layer 20, but the top layer is not as compressible as the bottom layer. In the present example both layers comprise closed cell foam. The first layer of foam should have a density of from about 30 to about 50 kg/m³, a compressibility of from about 110 kPa to about 210 kPa at 50% defection and the second layer should have a density of from about 90 to about 200 kg/m³, a compressibility of from about 400 kPa to about 700 kPa at 50%. In one preferred embodiment, the first layer is closed cell cross linked polyolefin foam having a minimum compression of 110 kPa at 50% defection and a maximum compression of 210 kPa at 50% deflection and an average Shore 00 hardness of about 61. The second layer in this embodiment has a compressibility of about 560 kPa at 50% deflection of 50% and a Shore hardness 0/00 of about 55/82.

The resilient multilayered hexagons 1 are evenly arranged, each resilient hexagonal block having a planar top and bottom surface 23 and 21, respectively, and being spaced from adjacent cubes by approximately 2 mm. The fabric 6 is a resiliently four way stretchable knitted fabric, preferably one comprising polyester or elastic fibers. The stretchable fabric used in connection with the invention may be made of synthetic fabric which is readily stretchable and expandable, preferably comprising expandable nylon/SPANDEX warp knit fabric treated with an INTERA process available from Intera Company, Limited. The treated fabric is available from Darlington company located in Augusta, Ga. In describing characteristics of the preferred treated fabric, the fabric has a “four-way stretch,” because it is capable of substantial stretching in different coplanar directions (e.g., perpendicular or other nonparallel directions taken along the plane of the fabric). For example, certain “non-stretch” fabrics may expand on the order of 10% to 20% when placed under substantial tension, oftentimes greater than that experienced under normal wearing conditions. The present invention, however, contemplates fabric which readily stretches 50% to 200% without tearing when tensioned under normal wearing conditions. The present invention also contemplates fabric having so-called “two-way” stretch, i.e., stretch in opposite (parallel) directions along a common direction line. As understood, so-called “four-way stretch” fabrics are typically made of artificial fibers woven with a warp knit and so-called “two-way stretch” fabrics are typically made of artificial fibers woven with a circular knit. A margin of fabric 6 is provided around the periphery of the hexagons 1. Along the edges of the fabric at opposite ends respectively there may be strips 3 of VELCRO™ or excess fabric to accomplish stitching, only one of which is shown.

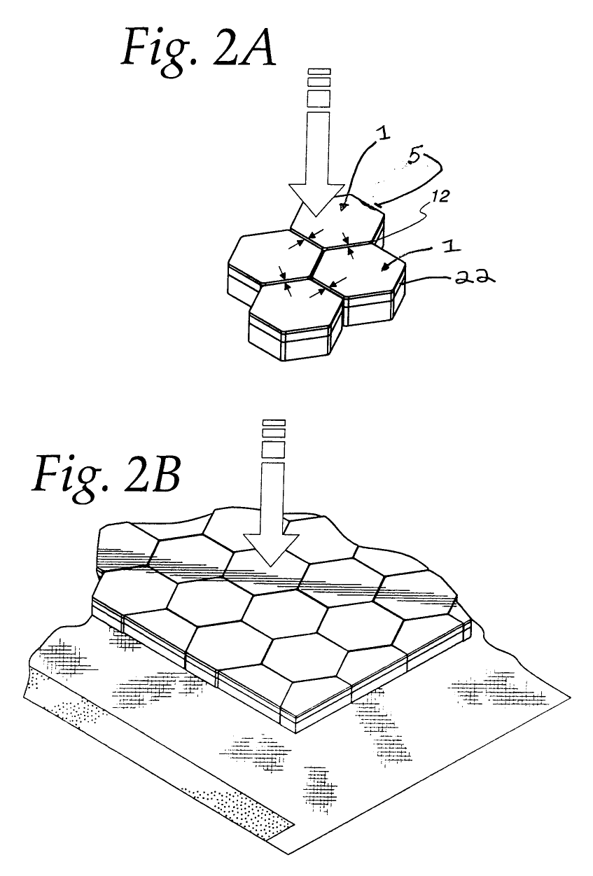

As seen in FIG. 2A when an object impacts the surface of outer layer 22, the outer circumferences 5 of the hexagonal elements 1 of the outer layer 22 move toward one another to close the gap 12 such that at least the outer layers of the elements nest and abut one another. The thickness of the elements, the distance of the elements from each other, the relative compressibilities and densities of the layers make the elements cooperate to permit the elements to coalesce, as seen in FIG. 2B, with each other such that the elements will have a continuous outer surface of the second layer in an impact area when laid on a planar surface and impacted with a force.

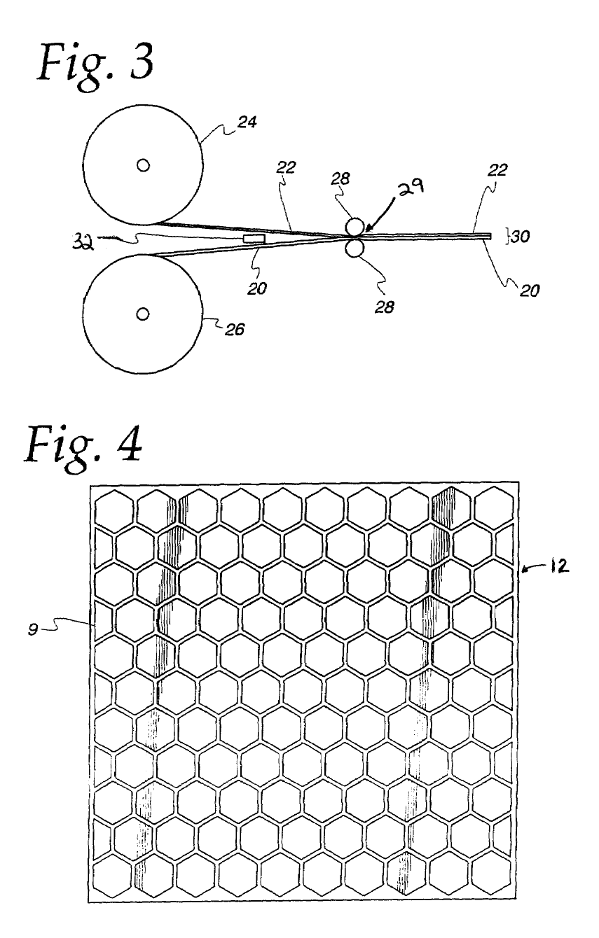

Referring to FIG. 3, the resilient multilayered elements are made from melt bonded foam webs. As shown in FIG. 3, a first layer web 20 is unwound from a roll 26. The first layer foam web has a density of from about 30 to about 50 kg/m³ and a compressibility of from about 110 to about 210 kPa at 50% defection. A second layer polymeric foam web 22 is unrolled from roll 24. The second layer foam has a density of from about 90 to about 200 kg/m³ and a compressibility of from 400 kPa to about 700 kPa at 50% defection. At least one of the layers is exposed to a heater 32 having a temperature of from about 700° F. to about 1000° F. to melt the surface of the layer(s). A flame melts the surface of the at least one of the first and second layers. The melted surfaces and webs are conveyed through a nip 29 of rolls 28 to provide a multilayered resilient web 30 with layers 20 and 22. After the formation of the multilayered web, the web is conveyed to a cutter which will form the array of multilayered resilient elements. The webs could also be adhesively bonded in lieu of heat bonding.

FIG. 4 shows a plan view of a cutter 12 used for manufacturing the material of FIG. 1. The cutter comprises blades 9 defining a plurality of hexagons of 14 mm sides and a total thickness which includes both layers of 12 mm. The top or outer layer 22 has a thickness of about 5 mm and the bottom layer 20 having a thickness of about 7 mm.

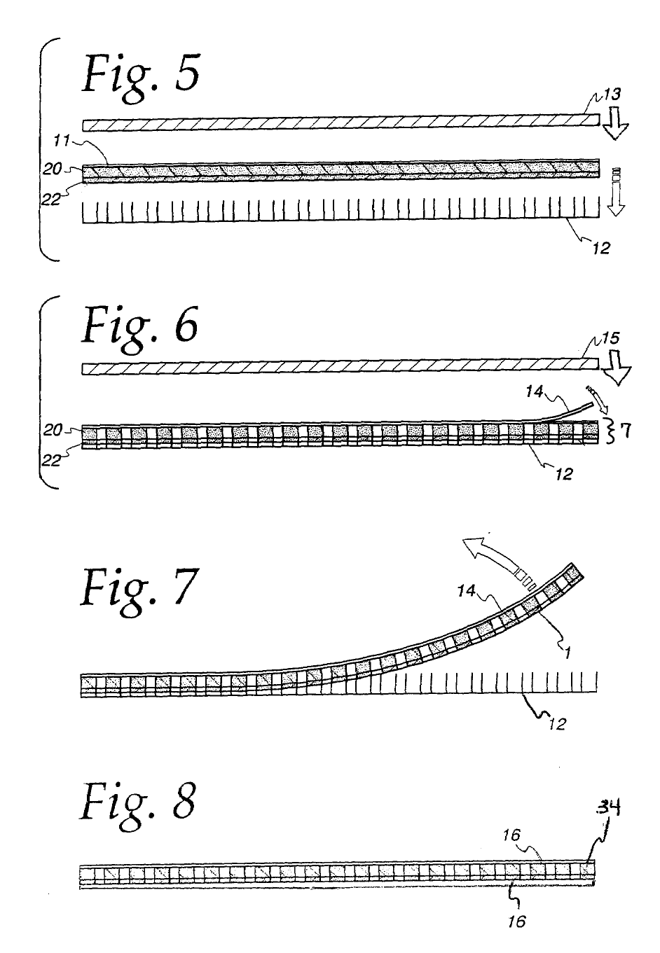

Preferably, at least said one side of the elements are coated with the hot-melt adhesive which is the form of a film prior to being cut into an array of resilient multilayered elements. Alternatively or in addition, the side of the substrate adjacent one side of the foam elements is coated with the hot-melt adhesive. A sheet of hot-melt film may also be interposed between said one side of the elements and the substrate to provide the adhesive layer. FIGS. 5 to 7 are vertical cross-sectional views of apparatus at various stages respectively throughout the manufacture of the flexible material shown in FIG. 1. Referring to these figures, the surface of layer 20 of the laminate 7 of the laminated layers is coated with a hot melt adhesive 11. The laminated foam 7 is then placed onto a cutter 12, of the type shown in FIG. 4, and pressed down with a press 13 so that the cutter 12 cuts through the laminated foam 7 to form a plurality of separate blocks. The press is then removed, whereupon owing to its resilient nature, the foam will tend to spring back slightly so that the exposed surface of each cube stands proud to lie above the surface of the cutter. Excess material from between the elements is then removed.

Next, as shown in FIG. 6, a layer of fabric 14 is placed over the foam and cutter 12 and a heated platen 15 is brought into contact with the fabric 14. Heat is conducted through the fabric 14 to the foam layer 20 and activates the adhesive, bonding the fabric 14 to the laminated foam 7. In this arrangement, the cutter grid acts as a jig, holding the foam cubes in position whilst the fabric substrate 14 is applied thereto. Garments that include the foam elements stitched into the garment may be machine washed in water having a temperature of up to about 140° F. For about 15 minutes and then dried in a dryer having a temperature from about 140° F. up to about 200° F. for about 40 minutes. Garments may be washed and dried more than about 50 times without detachment of the foam elements from the fabric.

An adhesive which will not only securely mount the small multilayered foam blocks to the substrate fabric, but also will permit the washing and drying of the flexible material with the blocks adhesively affixed thereto is a thermoplastic adhesive based upon ethyl vinyl acetate and/or polyethylene, and is fire resistant. Polyethylene is an addition polymer of ethylene or may be an addition ethylene/α-olefin interpolymer which is predominately ethylene derived units and where the comonomer (α-olefin) of ethylene is a C3 to C20 α-olefin. In one aspect the adhesive is fire resistant and contains brominated hydrocarbons and less than 25 weight percent di-antimonytrioxide. In an important aspect, the adhesive has a melting point of at least 250° F., and in and important aspect has a melting range of from 250 to 265° F. In an another aspect, the adhesive has a melt flow index (190° C./21.1N) of at least 2, preferably 3 and generally is in the range of from 3 to 5 g/10 minutes (under test DIN 53735). In another aspect, the adhesive has a washing resistance of at least about 85° F., preferably about 140° F. using test DIN 53920. The adhesive also may have a heat resistance of at least 200° F., and in general has a heat resistance of from 210° F. or more, such as 230° F. The adhesive also has a minimum bond line temperature of about 265° F., preferably about 285° F. In an important aspect, the adhesive is in the form of a film which may be applied to the surfaces of the small separate spaced foam blocks so that they may be heat sealed to the fabric surface or surfaces to which the plurality of foam blocks are bonded.

As shown in FIG. 7 after the removal of excess material the fabric can be lifted away from the cutter taking the foam hexagons 1 with it.

In an alternative method, ejectors are disposed in the cutter grid to eject the elements, leaving any waste material behind in the cutters.

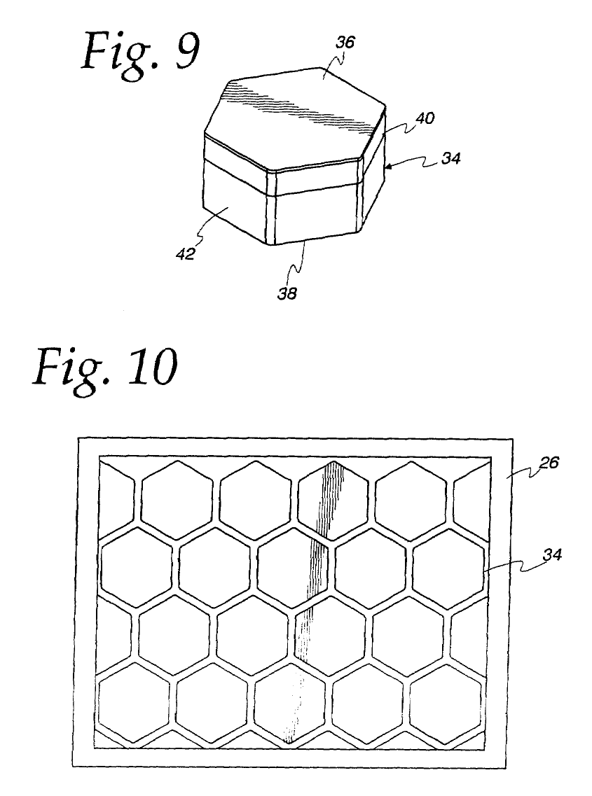

Referring to FIGS. 9 and 10, in a highly preferred aspect, the resilient multilayered elements are hexagonal in shape, as at 36 in FIG. 9, and are spaced from each other at least about 1 mm, and generally 1 mm to 4 mm apart where the sides of the hexagon are 10 to 15 mm across from each other, and generally from 3 mm to 6 mm apart where the sides of the hexagon are from about 16 mm to 35 mm from each other. The element 34 is made from a laminated foam comprising a layer 40 of relatively dense closed cell polyethylene foam heat bonded to a layer 42 of less dense closed cell polyethylene foam. As seen in FIG. 9, the top surface 36 and bottom surface 38 of the resilient element 34 are planar. The top surface 36 is not as porous as the under body 40 of the top layer.

If the laminated foam 10 is to be cut into relatively large pieces, in particular large irregularly shaped pieces such as may be suitable for use in an equestrian jacket, then these pieces may be assembled into a specially constructed jig to hold them into place before application of the fabric substrate 14. As described above, the sheet of resilient foam from which the elements are cut will have hot-melt adhesive applied to one or both surfaces prior to the cutting process.

In a further variation, the sheet of resilient material is cut into strips in a first direction using a plurality of rolling cutters. The sheet is cut in a second direction perpendicular to the first to form cubes. The cutters are then moved sideways to cut narrow strips of foam in both directions to space the cubes apart, the narrow strips of foam being stripped away to leave the cubes.

FIG. 8 shows another embodiment looking at the fabric substrate of flexible material similar to that shown in FIG. 1. The outline of element 34 can be seen through the fabric 16. A layer of fabric 16 is bonded to each of opposite sides of layered elements 34. This embodiment may be produced in a similar way to that shown in FIG. 1 except that opposite sides of the laminated foam layer, that is, the outer surfaces of layers 20 and 22 are coated with adhesive and, after the foam cubes bonded to a first layer of fabric have been removed from the cutter, a second layer of fabric is placed over the exposed surface of the elements and pressed with a heated platen to effect a bond.

In other variations to the above methods, the hot-melt adhesive may be applied to the surface the substrate rather or in addition to the sides of the flexible material. Alternatively or in addition, a hot-melt film can be interposed between the elements and the substrate.

Also, heated nip-rollers can be used in place of a heated platen to bond the elements to the substrate, particularly when substrate is bonded to both sides of the elements, which are thereby sandwiched therebetween. This facilitates passage of the material between the rollers prior to activation of the adhesive.

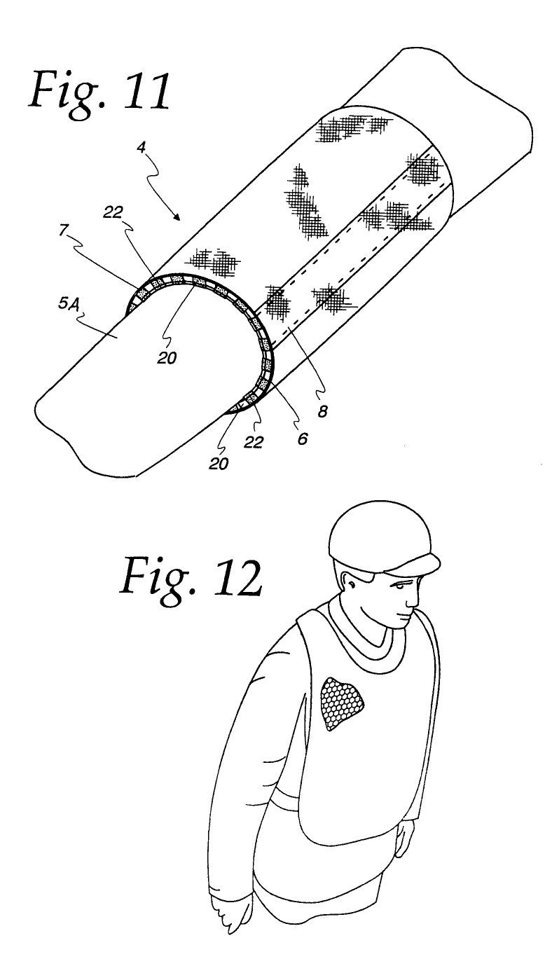

Protective articles made as discussed above may be used to produce protective clothing or other garments for human use. Referring to FIG. 11, a protective armband 4 is shown being worn on part of an arm 5 A. The armband 4 is formed from a generally rectangular piece of material of the type shown in FIG. 1, but which is this case comprises a fabric substrate 6 bonded to both sides thereof with a plurality of two layer cubes sandwiched therebetween. Margins are provided at opposite ends respectively of the substrate 6 and a strip of VELCRO™ 8 is fastened on this margin to enable opposite ends of the material to be fastened in an overlaying relationship to form a tube. By varying the degree of overlap of the ends, the tube can be closely fitted around arms of different sizes. The provision of a substrate layer 6 on both sides of the laminated cube foam elements 10 prevents the latter from separating too much as the material is curved around to form a tube. Rather, the substrate 6 on the outside of the armband is forced to stretch and the edges of the cubes 7 at the inner side of the armband are compressed. The provision of a substrate layer on both sides of the material therefore enables the material to continue to provide good protection, even when tightly flexed. As can be seen in FIG. 11 the harder outer layer 22 is to be worn away from the user while the less hard layer 20 is worn toward the user.

What is claimed is:

1. An article of protective material comprising:
an array of multilayered resilient elements having a planar top and bottom surface, the elements 5 mm to 20 mm thick and spaced at intervals of 1 mm to 6 mm from each other, the elements having a first layer having a compressibility of at least 110 kPa at 50% deflection and a density of at least 30 kg/m³ and a second layer having a compressibility of at least 400 kPa at 50% deflection and a density of at least 90 kg/m³, each of the first and second layers have a different density and compressibility, the first layer having a density which is less than the density of the second layer, the second layer having a compressibility less than the first layer, the thickness of the elements, the distance of the elements from each other, the relative compressibilities and densities of the layers making at least two of the elements effective to coalesce with each other such that the elements will have a continuous outer surface of the second layer in an impact area when laid on a planar surface and impacted with a force; and
a first resilient fabric substrate having the plurality of resilient elements affixed thereon in spaced apart relationship to one another, the resilient fabric having a stretchability of at least 50% without tearing.

2. The article of material according to claim 1 wherein the first layer has a a first compressibility of from about 110 kPa to about 210 kPa at 50 50% deflection and a density of from about 30 to about 50 kg/m³, and the second layer has a second compressibility of 400 kPa to about 700 kPa at 50% deflection which is less than the compressibility of the first layer, and a second density of from about 90 to about 200 kg/m³ which second density is less than the density of the first layer and wherein the impact force which makes the coalesce is a force which makes at least two of the elements compress at least about 10% .

3. The article of material according to claim 2 where the elements have a thickness of from 5 to 20 mm, the largest dimension between linear sides of the top and bottom surfaces is from 10 mm to 35 mm, and the elements are spaced from 1 mm to 6 mm from each other.

4. The article of material according to claim 3 wherein the elements are substantially hexagonal in cross-section.

5. The article of material according to claim 3 wherein the elements have a cross section which is substantially an equilateral triangle.

6. The article of material according to claim 1 where the protective material further comprises a second resilient fabric substrate affixed to the resilient elements opposite to the first resilient fabric substrate.

7. The article of material as recited in claim 3 wherein the first layer is a polymeric foam and the second layer is a polymeric foam, the first and second layers melt bonded to each other.

8. The article of material as recited in claim 3 wherein the elements have a hexagonal shape, the first layer is a polymeric foam and the second layer is a polymeric foam, the first and second layers melt bonded to each other.

9. A method of making protective material, the method comprising:
bonding a planar first layer of resilient foam to a planar second layer of resilient foam to provide a multilayered resilient web 5 mm to 20 mm thick, the first layer having a compressibility of at least 110 kPa at deflection of 50% and a density of at least 30 kg/m³ and the second layer having a compressibility of at least 400 kPa at a deflection of 50% and a density of at least 90 kg/m³, the first layer and the second layer each having a different density and compressibility, the first layer having a density which is less than the density of the second layer, the second layer having a compressibility less than the first layer;
cutting the multilayered resilient web to provide an array of multilayered resilient elements which have a planar top and bottom surface; and
adhesively affixing the array of planar multilayered resilient elements onto a first resilient fabric substrate having a stretchability of at least 50% without tearing, the multilayered resilient elements spaced on the fabric substrate at intervals of 1 mm to 6 mm from each other, the thickness of the elements, the distance of the elements from each other, the relative compressibilities and densities of the layers to permit at least two of the elements to coalesce with each other such that the elements will have a continuous outer surface of the second layer in an impact area when laid on a planar surface and impacted with a force.

10. The method as recited in claim 9 wherein the first layer has a first compressibility of from about 110 kPa to about 210 kPa at 50 50% defection and a first density of from about 30 to about 50 kg/m³, and the second layer has a second compressibility of from 400 kPa to about 700 kPa at 50% deflection and a second density of from about 90 to about 200 kg/m³, the second compressibility less than the compressibility of the first layer.

11. The method as recited in claim 10 wherein the method further comprises affixing a second resilient fabric substrate to the multilayered resilient elements opposite to the first resilient fabric substrate, the second resilient substrate having a stretchability of at least 50% without tearing.

12. The method as recited in claim 10 wherein the multilayered resilient web is cut into a plurality of separate, individual multilayered resilient elements each of which are adhesively affixed to the first resilient fabric substrate in spaced relation to each other.

13. The method as recited in claim 12 wherein the method further comprises affixing a second resilient fabric substrate to the multilayered resilient elements opposite to the first resilient fabric substrate.

14. The method as recited in claim 13 wherein the multilayered resilient web is cut into a plurality of separate, individual multilayered resilient elements each of which are adhesively affixed to the first resilient fabric substrate in spaced relation to each other.

15. A protective garment comprising:
a first resilient stretchable fabric to be worn toward the body of a user;
an array of multilayered resilient foam elements having a planar top and bottom surface, the elements 5 mm to 20 mm thick and spaced at intervals of 1 mm to 6 mm from each other, the elements having a first layer having a compressibility of at least 110 kPa at 50% deflection and a density of at least 30 kg/m³ and a second layer having a compressibility of at least 400 kPa at 50% deflection and a density of at least 90 kg/m³, each of the first and second layers have a different density and compressibility, the first layer having a density which is less than the density of the second layer, the second layer having a compressibility less than the first layer, the thickness of the elements, the distance of the elements from each other, the relative compressibilities and densities of the layers making the elements are effective to permit at least two of the elements to coalesce with each other such that the elements will have a continuous outer surface of the second layer in an impact area when laid on a planar surface and impacted with a force; and
a second resilient stretchable fabric bonded to the second foam layer to be worn away from the body of the user, the second resilient stretchable fabric having a stretchability of at least 50%.

16. The protective garment as recited in claim 15 wherein the elements have a cross section which is hexagonal or triangular and wherein the first layer has a first compressibility of from about 110 kPa to about 210 kPa at 50% deflection and a density of from about 30 to about 50 kg/m³, and the second layer has a second compressibility of 400 kPa to about 700 kPa at 50% deflection which is less than the compressibility of the first layer, and a second density of from about 90 to about 200 kg/m³ and wherein the impact force which makes the coalesce is a force which makes at least two of the elements compress at least about 10%.

17. The protective garment as recited in claim 16 wherein the first and second substrates are four way stretch fabrics.
